(19) United States
(12) Patent Application Publication
(10) Pub. No.: US 2001/0029849 A1
(43) Pub. Date: Oct. 18, 2001

(54) Marking device and marking method

(76) Inventors: Tetsuo Yano, Tokyo (JP); Yasunori Ohta, Tokyo (JP); Tetsuya Kudoh, Tokyo (JP)

Correspondence Address: OLIFF & BERRIDGE, PLC, 277 S. WASHINGTON STREET, SUITE 500, ALEXANDRIA, VA, 22314, US

(21) Appl. No.: 09/824,756

(22) Filed: Apr. 4, 2001

(30) Foreign Application Priority Data
Apr. 18, 2000 (JP) JP 2000-116836

(51) Int. Cl. B31F 1/00; B41F 19/00

(52) U.S. Cl. 101/3.1; 101/32

(57) ABSTRACT

A marking device comprises: a marking mechanism for marking a surface to be processed, of an object to be marked, by reciprocating a marking portion; a marking portion moving mechanism for moving the marking portion in two-dimensional directions along the surface to be processed; and a pressure adjusting circuit for keeping a constant pressure which the marking portion applies to the surface to be processed; wherein the marking mechanism comprises a cam mechanism for linearly reciprocating the marking portion by following a cam which is rotated by a driving member.

### BACKGROUND OF THE INVENTION

1. Field of the Invention

The present invention relates to a marking device and a marking method for marking a production number, a product name, or the like, on a surface of component made of metal, synthetic resin or the like.

2. Description of the Related Art

As a marking device according to an earlier development, which is disclosed in, for example, the Japanese Patent Publication No. Tokukou-hei 3-27397, a marking device having a pressure adjusting mechanism for making a marking depth uniform without depending on a slant or a curvature of a surface to be processed, by applying a constant air pressure to a pressurizing rod with a pressure regulator, has been known.

Further, there is a marking device which is operated as follows. When a line to be marked on a surface is not continuous or when a marking portion moves between two positions in which each character is marked on a surface, the marking portion is separated from the surface to be processed, by a reciprocating mechanism part. After the marking portion moves to the next marking position in two-dimensional directions, the marking portion moves to the surf ace to be processed, by the reciprocating mechanism part, to mark the next character.

However, in the marking device disclosed in the Japanese Patent Publication No. Tokukou-hei 3-27397, in order to keep the constant pressure to be applied to the pressurizing rod, it was necessary to adjust a moving speed of a pen which was attached to an end of the pressurizing rod and a pressing force of the pen by changing the pressure setting value of the pressure regulator by hand or by setting a velocity adjusting valve to an inlet or an outlet of a feed pipe for compressed air. Because it is necessary to adjust the pressure to be applied to the pressurizing rod in accordance with the characteristics of an object to be marked, such as material, shape, hardness and the like, it takes a lot of time and labor to adjust the pressure.

In order to automatically adjust the pressure, it is necessary to provide a pressure sensor for detecting a pressing force of the pen and to automatically adjust a velocity adjusting valve which is set to the inlet or the outlet of the feed pipe for compressed air and a pressure regulator. However, when the structure of the device becomes complicated and the size of the device becomes large, the product cost of the device becomes higher. Because the air for adjusting the pressure is compressed fluid, the air pressure control has a poor response. As a result, it is difficult to automatically control the air pressure.

Further, in case that a plurality of characters or the like are marked on the object, when a line to be marked is not continuous, or when the marking portion moves between two positions in which each character is marked, it takes a lot of time to separate the marking portion from the surface to be processed, or to bring the marking portion into contact with the surface to be processed. There is a problem that the separating and bringing operations account for much of the whole marking time.

### SUMMARY OF THE INVENTION

In order to solve the above-described problems, an object of the present invention is to provide a marking device and a marking method, in which the pressing force to be applied to the object to be marked, can be automatically controlled by a cheap and simple structure, and in which time for moving the marking portion when a line to be marked is not continuous or when two characters are apart from each other, can be shortened in order to shorten the whole marking time.

That is, in accordance with one aspect of the present invention, a marking device (for example, a marking device 10 shown in FIG. 1) comprises:

a marking mechanism (for example, a reciprocating mechanism part 1 shown in FIG. 1) for marking a surface to be processed, of an object to be marked, by reciprocating a marking portion (for example, a stylus 1g shown in FIG. 1);

a marking portion moving mechanism (for example, a two-dimension positioning mechanism part 3 shown in FIG. 1) for moving the marking portion in two-dimensional directions along the surface to be processed; and

a pressure adjusting circuit (for example, a pressure control circuit 2 shown in FIG. 1) for keeping a constant pressure which the marking portion applies to the surface to be processed;

wherein the marking mechanism comprises a cam mechanism for linearly reciprocating the marking portion by following a cam which is rotated by a driving member (for example, a motor 1a shown in FIG. 1).

According to one aspect of the present invention, because the pressing force applied to the object to be marked is directly detected by utilizing the reactive force from the marking portion, and the pressing force can keep constant, the marking device can adjust the pressure with a simple and small structure.

The marking device may further comprise a contact detecting circuit (for example, a current detecting resistance 28 shown in FIG. 4) for detecting a contact between the surface to be processed and the marking portion by a change in a value of a current flowing into the driving member;

wherein when the contact between the surface to be processed and the marking portion is detected by the contact detecting circuit, the pressure adjusting circuit (for example, a pressure control circuit 2 shown in FIG. 1) adjusts the pressure which is applied to the surface to be processed, in accordance with the change in the value of the current.

Therefore, the marking device can mark a character or the like on the object to be marked, by moving the marking portion at the most suitable speed and with the most suitable pressing force in accordance with the weight of the marking mechanism or the contact position of the surface to be processed.

In accordance with another aspect of the present invention, a marking method comprises the steps of:

marking a surface to be processed, of an object to be marked, by following a cam which is rotated by a driving member to reciprocate a marking portion;

moving the marking portion in two-dimensional directions along the surface to be processed;

detecting a contact between the surf ace to be processed and the marking portion by a change in a value of a current flowing into the driving member; and

keeping a constant pressure which the marking portion applies to the surface to be processed in accordance with the change in the value of the current, when the contact between the surface to be processed and the marking portion is detected in the detecting step.

The marking device may further comprise a warning output circuit (for example, an amplifier 29 shown in FIG. 4) for outputting a warning when the contact between the surface to be processed and the marking portion is not detected by the contact detecting circuit while the marking mechanism (for example, a reciprocating mechanism part 1 shown in FIG. 1) linearly reciprocates the marking portion.

The marking method may further comprise a step of outputting a warning when the contact between the surface to be processed and the marking portion is not detected in the detecting step while the marking portion is linearly reciprocated in the marking step.

Because a user can soon recognize that the marking mechanism is in a position that the marking portion cannot mark a character or the like on the object to be marked, it is possible to shorten marking time and to save the power.

The marking mechanism (for example, a reciprocating mechanism part 1 shown in FIG. 1) may comprise a cam having a cam curvature so that a torque which is applied to the driving member by the contact between the marking portion and the surface to be processed, is kept constant without depending on a position of the contact of the surface to be processed.

Because the torque applied to the driving member keeps constant, it is possible to mark a character or the like in a uniform depth without depending on the contact position that the marking portion is in contact with the surface to be processed.

In accordance with another aspect of the present invention, a marking device (for example, a marking device 10 shown in FIG. 1) comprises:

a marking mechanism (for example, a reciprocating mechanism part 1 shown in FIG. 1) for marking a surface to be processed, of an object to be marked, by reciprocating a marking portion (for example, a stylus 1g shown in FIG. 1) of which an end is vibrated;

a marking portion moving mechanism (for example, a two-dimension positioning mechanism part 3 shown in FIG. 1) for moving the marking portion in two-dimensional directions along the surface to be processed; and

a pressure adjusting circuit (for example, a pressure control circuit 2 shown in FIG. 1) for keeping a constant pressure which the marking portion applies to the surface to be processed;

wherein the pressure adjusting circuit weakens the pressure which is applied to the surface to be processed, and stops vibrating the end of the marking portion, when a line to be marked is not continuous or when the marking portion moves between two positions in which each character is marked on the surface to be marked; and

the marking portion moving mechanism moves the marking portion to a next position to be marked in the two-dimensional directions.

In accordance with another aspect of the present invention, a marking method comprises the steps of:

marking a surface to be processed, of an object to be marked, by reciprocating a marking portion of which an end is vibrated;

weakening a pressure which is applied to the surface to be processed, to keep the pressure constant, and stopping vibrating the end of the marking portion, when a line to be marked is not continuous or when the marking portion moves between two positions in which each character is marked on the surface to be marked; and

moving the marking portion to a next position to be marked in two-dimensional directions.

According to another aspect of the present invention, when a line to be marked is not continuous, or when the marking portion moves between two positions in which each character is marked, the marking portion hardly reciprocates. Therefore, it is possible to dramatically shorten time for the marking. Further, because time for operating the marking mechanism is shortened, it is possible to improve the durability of the marking mechanism. Therefore, the possibility of the breakdown can be improved.

In accordance with another aspect of the present invention, a marking device comprises:

a marking portion moving mechanism for moving a marking portion;

a reciprocating mechanism for reciprocating the marking portion;

a pressure control circuit for controlling a pressure which a marking portion applies to a surface to be marked; and

wherein when the marking portion moving mechanism moves the marking portion without marking the surface to be marked, the reciprocating mechanism stops reciprocating the marking portion, the pressure control circuit weakens the pressure so as to hardly mark the surface to be marked, and the marking portion is moved along the surface to be marked.

In accordance with another aspect of the present invention, a marking method comprises the steps of:

moving a marking portion;

reciprocating the marking portion;

controlling a pressure which a marking portion applies to a surface to be marked; and

wherein when the marking portion is moved without marking the surface to be marked, the marking portion stops being reciprocated, the pressure is weakened so as to hardly mark the surface to be marked, and the marking portion is moved along the surface to be marked.

### BRIEF DESCRIPTION OF THE DRAWINGS

The present invention will become more fully understood from the detailed description given hereinbelow and the accompanying drawings which are given by way of illustration only, and thus are not intended as a definition of the limits of the present invention, and wherein;

FIG. 1 is a view showing a schematic construction of the marking device according to the first embodiment to which the present invention is applied;

FIG. 2 is a schematic perspective view of the reciprocating mechanism part shown in FIG. 1;

FIG. 3 is a view showing a dynamical relation between the cam and the cam follower shown in FIG. 1;

FIG. 4 is a block diagram showing a construction of the pressure control circuit according to the first embodiment, which is shown in FIG. 1;

FIG. 5 is a block diagram showing a construction of the pressure control circuit according to the second embodiment; and

FIG. 6 is a view showing an example of the marking which is carried out by the marking device according to the second embodiment.

### PREFERRED EMBODIMENT OF THE INVENTION

First Embodiment

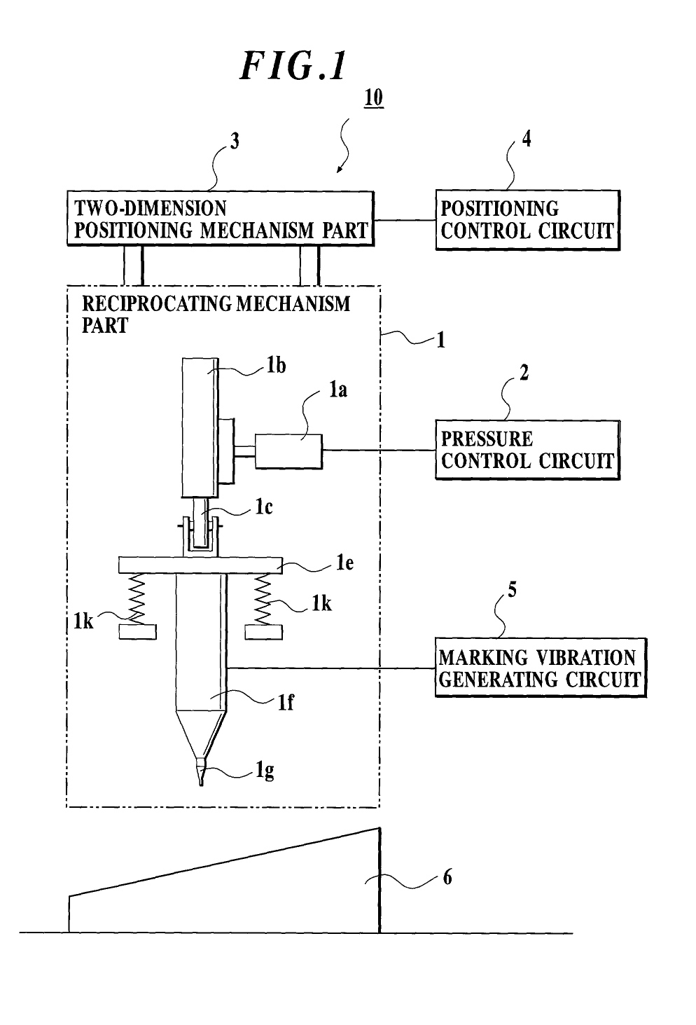

Hereinafter, the first embodiment of the marking device according to the present invention will be explained in detail with reference to FIGS. 1 to 4.

The construction of the marking device will be explained.

FIG. 1 is a view showing a schematic construction of a marking device 10 according to the first embodiment to which the present invention is applied.

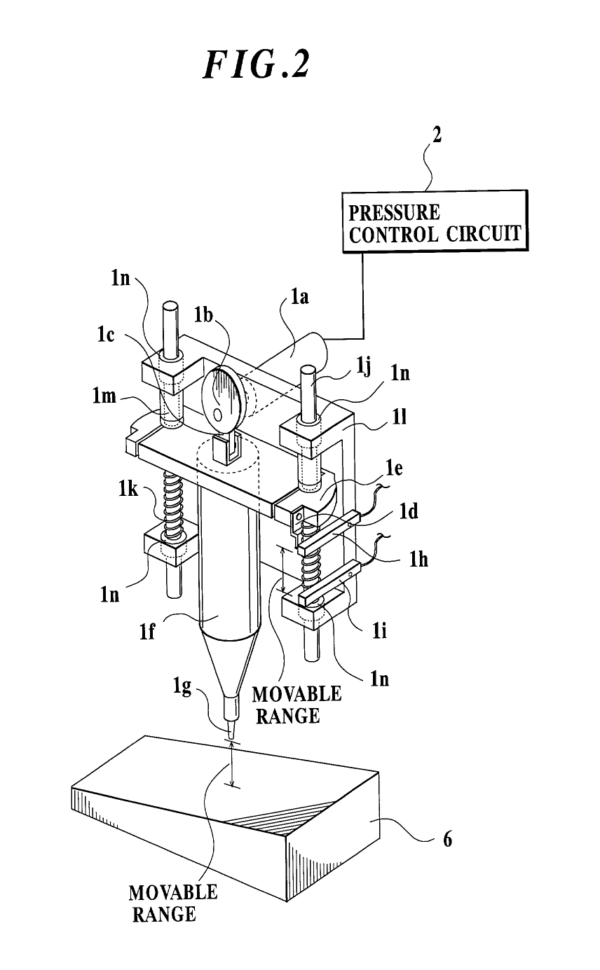

In FIG. 1, the marking device 10 comprises a reciprocating mechanism part 1, a pressure control circuit 2, a two-dimension positioning mechanism part 3, a positioning control circuit 4 and a marking vibration generating circuit 5. As shown in FIG. 2, the reciprocating mechanism part 1 comprises a motor 1a, a cam 1b, a cam follower 1c, a dog 1d, a holding portion 1e, a pen 1f, a stylus 1g, a moving up limit detecting portion 1h, a moving down limit detecting portion 1i, two shafts 1j and 1j, a coil spring 1k, a fixing plate 1l, a stopper 1m, four bearings 1n and the like.

The motor 1a is attached to the fixing plate 1l. When the motor 1a drives to rotate the cam 1b, the holding portion 1e moves linearly via the cam follower 1c. The holding portion 1e is fixed to two shafts 1j and 1j, and is always pressed to the cam 1b side by the coil spring 1k. Therefore, even though the holding portion 1e is pressed down to the object 6 to be marked, by rotating the cam 1b, or even though the holding portion 1e is separated from the object 6 to be marked, the holding portion 1e is movable by following the cam 1b.

The cam 1b has a shape so that the stylus 1g attached to the end portion of the pen 1f can be pressed to the object 6 to be marked under a constant pressure generated by a constant torque of the motor 1a without depending on a rotating position of the cam 1b within the movable range of the stylus 1g. The stylus 1g is made of a material having a higher hardness than that of the object 6 to be marked. The stylus 1g repeatedly marks a plurality of dots on the object 6 to be marked, by vibrating the stylus 1g in a upper and lower direction at a high speed.

The bearings 1n are incorporated into the fixing plate 1l. The shafts 1j and 1j move linearly by being guided by the bearings 1n. The cam follower 1c and the pen 1f are attached to the holding portion 1e. The moving up limit detecting portion 1h detects the dog 1d when the end of the pen 1f attached to the bottom surface of the holding portion 1e is in a moving up limit position, that is, the position that the pen 1f cannot move up any more. The moving down limit detecting portion 1i detects the dog 1d when the end of the pen 1f is in a moving down limit position, that is, the position that the pen 1f cannot move down any more.

The pressure control circuit 2 controls the speed of the reciprocating motion of the pen 1f by controlling the rotation speed of the motor 1a as described below. When the pen 1f is in contact with the object 6 to be marked during the reciprocating motion of the pen 1f, the pressure control circuit 2 detects that the pen 1f reaches the object 6 to be marked. After the pen 1f is in contact with the object 6 to be marked, the pressure control circuit 2 control the pressure which the pen if applies to the object 6 to be marked, so as to have a constant value. When the stylus 1g reaches the moving down limit position without contacting with the object 6 to be marked, the motor 1a rotates reversely. When the stylus 1g reaches the moving up limit position, the motor 1a stops and a warning is given to a user.

The two-dimension positioning mechanism part 3 positions a two-dimensional pattern, such as, a character, a number, or the like, in a direction normal to a marking axis, in accordance with a positioning signal outputted from the positioning control circuit 4. The reciprocating mechanism part 1 brings the pen 1f into contact with the object 6 to be marked, in a state of vibrating the pen 1f. A character or a number is marked on the object 6 to be marked. The marking vibration generating circuit 5 gives a vibration to the pen 1f.

The operation of the marking device 10 will be explained below.

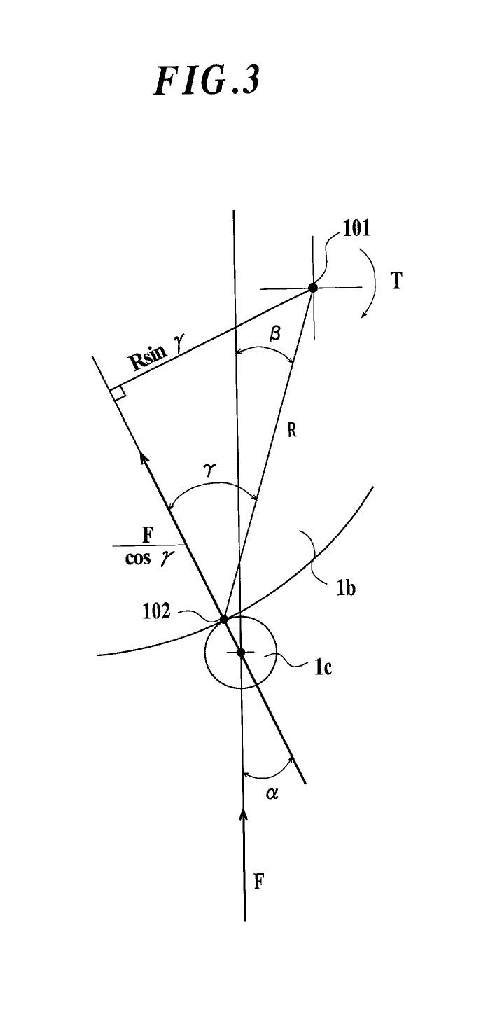

As shown in FIG. 3, a dynamical system of the cam mechanism will be explained. In FIG. 3, the reference numeral 101 denotes a support of the cam 1b which is a rotation shaft of the motor 1a, and 102 denotes a contact point between the cam 1b and the cam follower 1c. The reference “R” denotes a distance between the support 101 and the contact point 102, “F” denotes a reactive force from the object 6 to be marked, and “T” denotes a torque produced by the reactive force “F” at the support 101. The reference “α” denotes an angle between the reactive force “F” direction and a direction that a reaction force of the cam follower 1c is applied to the cam 1b, “β” denotes an angle between the reactive force “F” direction and the distance “R” direction, and “γ” denotes an angle between the reactive force “F” direction and a force “F/(cos α)” direction.

The torque “T” generated by the reactive force “F” from the object 6 to be marked, at the support 101 is determined by a resultant force “F/(cos α)” between a reactive force from a mechanism part for regulating the central shaft of the cam follower 1c to a linear motion and the reactive force “F”, and a distance “R sin γ” between the support 101 and the line that the regulated central shaft moves. These factors have the following relations.

T=(F/ cos α)×R sin γ (1)

γ=α+β (2)

In these equations, in case that each predetermined value is given to the reactive force “F” and the torque “T”, each initial value of the distance “R” and the angles “α” and “β” is determined by considering a suitable component arrangement within the movable range of the pen 1f. In this case, because the angle “α” hardly changes by changing each position of the components within the movable range, the relation between the distance “R” and the angle “β” can be determined by the equation (1). Thereby, a cam curvature that the reactive force “F” and the torque “T” are constant, can be obtained.

Therefore, a pressure which is applied to the object 6 to be marked when a constant torque is applied to the cam 1b by the motor 1a, can keep constant by suitably changing the distance between the support and the contact point in accordance with the rotation of the cam 1b having a curvature form which satisfies the above equations. Precisely, the reactive force “F” is changed in accordance with the change of a length of the coil spring 1k. However, the change of the reactive force “F” is much smaller than the pressure to be applied to the object 6 to be marked. Therefore, the change of the reactive force “F” can be ignored.

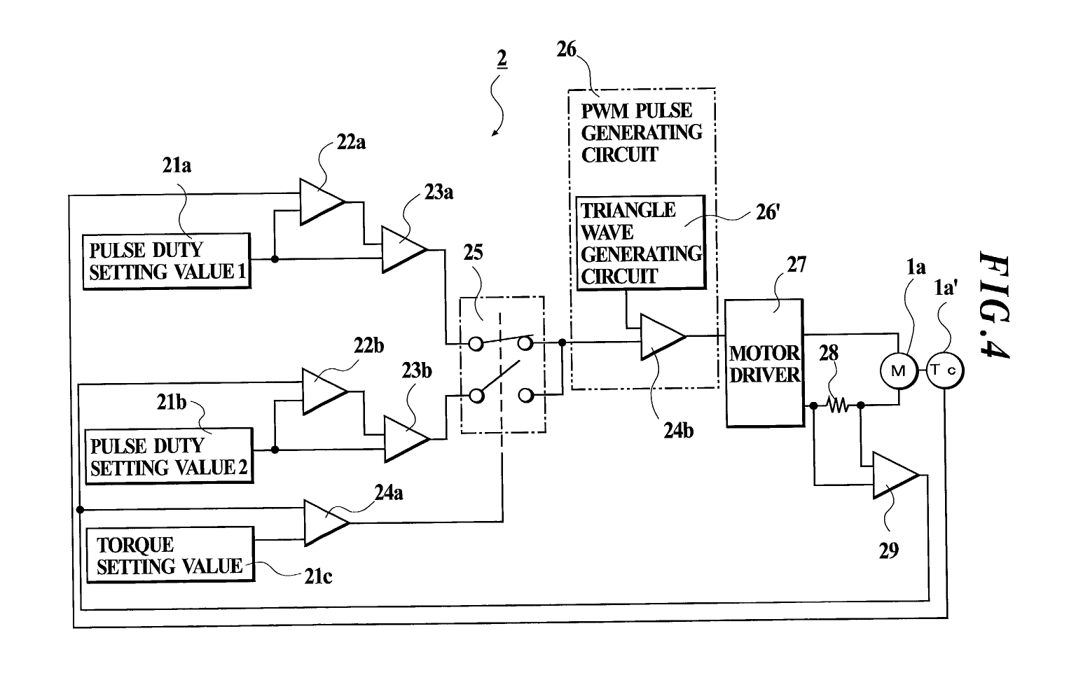

The operation of the pressure control circuit 2 will be explained with reference to FIG. 4. The speed control method for the pen 1f will be explained.

The rotation speed of the motor 1a is detected by attaching a tachometer 1a′ to the motor 1a. By a subtracter 22a and an adder 23a, a difference between the value obtained by detecting the rotation speed of the motor 1a and a pulse duty setting value stored in a pulse duty setting unit 21a, is added to the above pulse duty setting value in order to generate a signal having the added value.

A switch 25 outputs the generated signal to a comparator 24a in order to generate a comparative signal for comparing the generated signal with a triangle wave outputted from the triangle wave generating circuit 26′ of the PWM pulse generating circuit 26. Thereby, the rotation speed of the motor 1a is controlled so that the output signal of the tachometer 1a′ maintains the predetermined value set by the pulse duty setting unit 21a. By the above-described operation, the pressure control circuit 2 can control the reciprocating motion of the pen 1f at an optional speed.

The method for detecting that the pen 1f reaches the object 6 to be marked will be explained.

When a DC servo motor is used as a motor 1a, a current value of the DC servo motor is proportional to the torque. However, when the stylus 1g is in contact with the object 6 to be marked, the motion of the pen 1f is stopped. Therefore, the torque of the motor 1a is temporarily excessive. The voltage of both ends of a current detecting resistance 28 is detected by inputting the voltage into an amplifier 29. Then, the comparator 24a compares the detected voltage with a torque setting value which is previously stored in a torque setting unit 21c, in order to detect that the pen 1f reaches the object 6 to be marked. When it is not detected that the pen if reaches the object 6 to be marked, the amplifier 29 stops the motor 1a and a warning is given to a user. By the above-described operation, the pressure control circuit 2 can detect that the pen 1f is in contact with the object 6 to be marked, during the reciprocating motion of the pen 1f.

The method for controlling a pressure to be applied to the pen 1f will be explained.

A subtracter 22b compares an output value of the amplifier 29, which is a signal proportional to the torque “T”, with a pulse duty setting value which is stored in a pulse duty setting unit 21b, and outputs a difference between the output value of the amplifier 29 and the pulse duty setting value of the pulse duty setting unit 21b. An adder 23b generates a signal having a value obtained by adding the above difference to the pulse duty setting value.

The switch 25 outputs the generated signal to a comparator 24b in order to generate a comparative signal for comparing the generated signal with a triangle wave outputted from the triangle wave generating circuit 26′ of the PWM pulse generating circuit 26. Thereby, the torque of the motor 1a is controlled so that the output signal of the amplifier 29 is equal to the pulse duty setting value which is previously set by the pulse duty setting unit 21b. By the above-described operation, the pressure control circuit 2 can control the pressure which the pen if applies to the object 6 to be marked, so as to have a constant value.

As described above, because the pressure control circuit 2 controls the switch 25 in accordance with the signal for detecting that the pen 1f reaches the object 6 to be marked, the difference in weight between one type of pen and another type does not influence the strength of the impact on the object 6 to be marked. Various types of pen can be used. Further, it is possible to control the speed of the pen 1f and the pressure which the pen 1f applies to the object 6 to be marked, so that the pressing force of the stylus 1g has the most suitable value. Therefore, the marking device for uniformly marking a character or the like on a surface to be processed, without depending on a material or a shape of the object 6 to be marked, can be constructed cheaply and simply.

Second Embodiment

Hereinafter, the second embodiment of the marking device according to the present invention will be explained.

The construction of the marking device will be explained.

The schematic construction of the marking device according to the second embodiment to which the present invention is applied, is approximately the same as that of the marking device 10 (shown in FIG. 1) according to the first embodiment. The drawings and the explanation thereof are omitted.

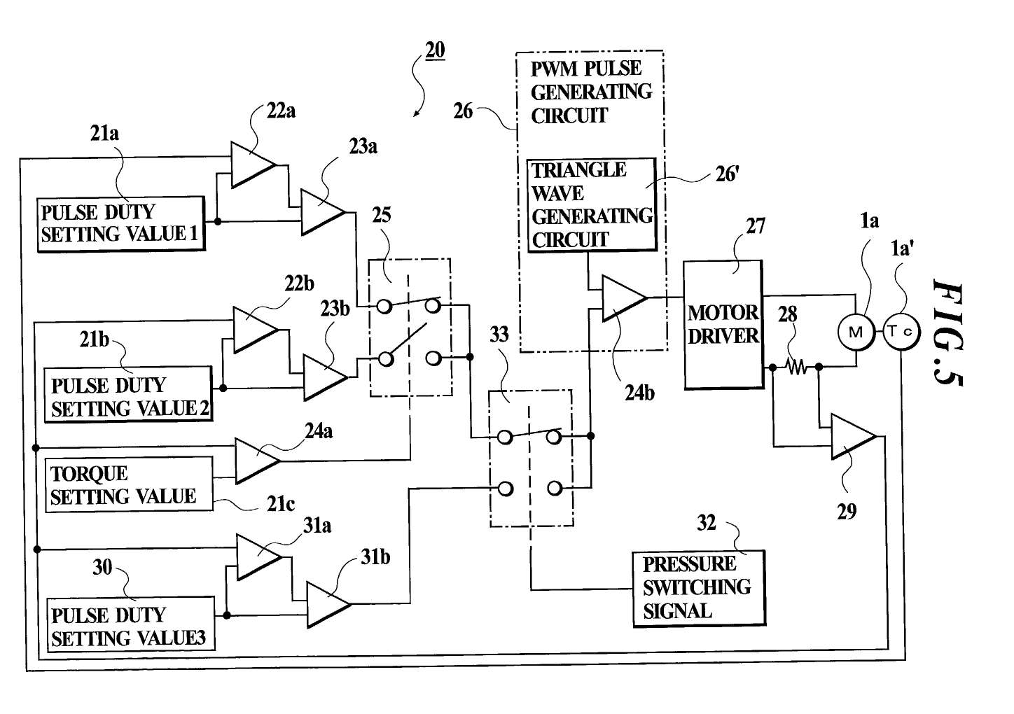

As shown in FIG. 5, the pressure control circuit 20 has a construction that a pulse duty setting unit 30, a subtracter 31a, an adder 31b, a pressure switching signal generating unit 32 and a switch 33 are further provided in the pressure control circuit 2 shown in FIG. 2.

In the operation of the pressure control circuit 20, the operation which is different from that of the pressure control circuit 2 will be explained with reference to FIG. 5.

In this figure, the subtracter 31a compares the output value of the amplifier 29 with the pulse duty setting value which is stored in the pulse duty setting unit 30, and outputs a difference between the output value of the amplifier 29 and the pulse duty setting value of the pulse duty setting unit 30. An adder 31b generates a signal having a value obtained by adding the above difference to the pulse duty setting value.

The switch 33 outputs the generated signal to a comparator 24b in order to generate a comparative signal for comparing the generated signal with a triangle wave outputted from the triangle wave generating circuit 26′ of the PWM pulse generating circuit 26. Thereby, the output signal is controlled so as to maintain the predetermined value set by the pulse duty setting unit 30.

In the pulse duty setting unit 30, a pulse duty setting value corresponding to a torque in which the pen 1f hardly applies a force to the object 6 to be marked, is previously set.

The pressure control circuit 20 controls the torque of the motor 1a so as to become a torque in which the pen 1f hardly applies a force to the object 6 to be marked, by controlling the switch 33 in accordance with the pressure switching signal outputted from the pressure switching signal generating unit 32. Therefore, when a line to be marked is not continuous, or when the pen if moves between two positions in which each character is marked on a surface, the pen if can move to the next marking position without applying a force to a surface to be processed. Further, time for moving the pen if can be shorten.

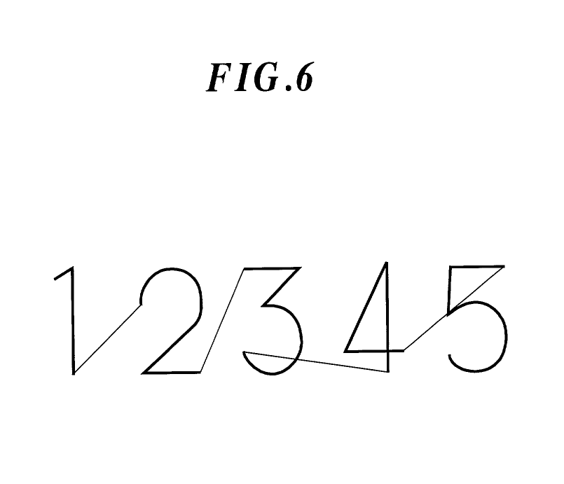

In FIG. 6, an example of the marking of a plurality of numbers 1 to 5, which is carried out by the marking device according to the second embodiment, is shown. In this figure, each thin line from an end point of a number to a start point of the next number, is one formed by decreasing a pressing force of the pen, stopping the vibration of the end of the marking portion, and moving the pen in two-dimensional directions, that is, along the surface to be processed.

When the pen moves to the next marking position, the end of the marking portion (stylus 1g) does not applies a force to the surface to be marked, but drags on the surface. Therefore, thin lines (scratches) are formed on the surface. However, if the object to be marked does not have a clear surface like a mirror-surface, it is difficult to look for the thin lines. The thin lines does not deteriorate a quality of a marked character.

According to one aspect of the present invention, because the pressing force applied to the object to be marked is directly detected by utilizing the reactive force from the marking portion, and the pressing force can keep constant, the marking device can adjust the pressure with a simple and small structure.

Further, the marking device can mark a character or the like on the object to be marked, by moving the marking portion at the most suitable speed with the most suitable pressing force in accordance with the weight of the marking mechanism or the contact position of the surface to be processed.

Further, because a user can soon recognize that the marking mechanism is in a position that the marking portion cannot mark a character or the like on the object to be marked, it is possible to shorten marking time and to save the power.

Further, because the torque applied to the driving member keeps constant, it is possible to mark a character or the like in a uniform depth without depending on the contact position that the marking portion is in contact with the surface to be processed.

According to another aspect of the present invention, when a line to be marked is not continuous, or when the marking portion moves between two positions in which each character is marked, the marking portion hardly reciprocates. Therefore, it is possible to dramatically shorten time for the marking. Further, because time for operating the marking mechanism is shortened, it is possible to improve the durability of the marking mechanism. Therefore, the possibility of the breakdown can be improved.

The entire disclosure of Japanese Patent Application No. Tokugan 2000-116836 filed on Apr. 18, 2000 including specification, claims drawings and summary are incorporated herein by reference in its entirety.

What is claimed is:

1. A marking device comprising:
a marking mechanism for marking a surface to be processed, of an object to be marked, by reciprocating a marking portion;
a marking portion moving mechanism for moving the marking portion in two-dimensional directions along the surface to be processed; and
a pressure adjusting circuit for keeping a constant pressure which the marking portion applies to the surface to be processed;
wherein the marking mechanism comprises a cam mechanism for linearly reciprocating the marking portion by following a cam which is rotated by a driving member.

2. The marking device as claimed in claim 1, further comprising a contact detecting circuit for detecting a contact between the surface to be processed and the marking portion by a change in a value of a current flowing into the driving member;
wherein when the contact between the surface to be processed and the marking portion is detected by the contact detecting circuit, the pressure adjusting circuit adjusts the pressure which is applied to the surface to be processed, in accordance with the change in the value of the current.

3. The marking device as claimed in claim 2, further comprising a warning output circuit for outputting a warning when the contact between the surface to be processed and the marking portion is not detected by the contact detecting circuit while the marking mechanism linearly reciprocates the marking portion.

4. The marking device as claimed in claim 1, wherein the marking mechanism comprises a cam having a cam curvature so that a torque which is applied to the driving member by the contact between the marking portion and the surface to be processed, is kept constant without depending on a position of the contact of the surface to be processed.

5. A marking method comprising the steps of:
marking a surface to be processed, of an object to be marked, by following a cam which is rotated by a driving member to reciprocate a marking portion;
moving the marking portion in two-dimensional directions along the surface to be processed;
detecting a contact between the surface to be processed and the marking portion by a change in a value of a current flowing into the driving member; and
keeping a constant pressure which the marking portion applies to the surface to be processed in accordance with the change in the value of the current, when the contact between the surface to be processed and the marking portion is detected in the detecting step.

6. The marking method as claimed in claim 5, further comprising a step of outputting a warning when the contact between the surface to be processed and the marking portion is not detected in the detecting step while the marking portion is linearly reciprocated in the marking step.

7. A marking device comprising:
a marking mechanism for marking a surface to be processed, of an object to be marked, by reciprocating a marking portion of which an end is vibrated;
a marking portion moving mechanism for moving the marking portion in two-dimensional directions along the surface to be processed; and
a pressure adjusting circuit for keeping a constant pressure which the marking portion applies to the surface to be processed;
wherein the pressure adjusting circuit weakens the pressure which is applied to the surface to be processed, and stops vibrating the end of the marking portion, when a line to be marked is not continuous or when the marking portion moves between two positions in which each character is marked on the surface to be marked; and
the marking portion moving mechanism moves the marking portion to a next position to be marked in the two-dimensional directions.

8. A marking method comprising the steps of:
marking a surface to be processed, of an object to be marked, by reciprocating a marking portion of which an end is vibrated;
weakening a pressure which is applied to the surface to be processed, to keep the pressure constant, and stopping vibrating the end of the marking portion, when a line to be marked is not continuous or when the marking portion moves between two positions in which each character is marked on the surface to be marked; and
moving the marking portion to a next position to be marked in two-dimensional directions.

9. A marking device comprising:
a marking portion moving mechanism for moving a marking portion;
a reciprocating mechanism for reciprocating the marking portion;
a pressure control circuit for controlling a pressure which a marking portion applies to a surface to be marked; and
wherein when the marking portion moving mechanism moves the marking portion without marking the surface to be marked, the reciprocating mechanism stops reciprocating the marking portion, the pressure control circuit weakens the pressure so as to hardly mark the surface to be marked, and the marking portion is moved along the surface to be marked.

10. A marking method comprising the steps of:
moving a marking portion;
reciprocating the marking portion;
controlling a pressure which a marking portion applies to a surface to be marked; and
wherein when the marking portion is moved without marking the surface to be marked, the marking portion stops being reciprocated, the pressure is weakened so as to hardly mark the surface to be marked, and the marking portion is moved along the surface to be marked.
